(19) United States
(12) Patent Application Publication
(10) Pub. No.: US 2025/0168809 A1
(43) Pub. Date: May 22, 2025

(54) A METHOD, APPARATUS AND COMPUTER PROGRAM PRODUCT FOR REDUCTION OF INTERFERENCE IN LOCATION DETERMINATION

(71) Applicant: Nokia Technologies Oy, Espoo (FI)

(72) Inventors: Oana-Elena BARBU, Aalborg (DK); Nuno Manuel KIILERICH PRATAS, Aalborg (DK)

(21) Appl. No.: 18/870,273

(22) PCT Filed: Jun. 1, 2022
(86) PCT No.: PCT/EP2022/064878

§ 371 Date: Nov. 27, 2024

(51) Int. Cl. H04W 64/00; H04L 5/00; H04W 24/08; H04W 92/18

(52) U.S. Cl. CPC H04W 64/00; H04L 5/0048; H04W 24/08; H04W 92/18

(57) ABSTRACT

There is disclosed methods, apparatuses and computer program products for enhanced accuracy positioning. In accordance with an embodiment, the method comprises determining that a first user equipment is likely to experience positioning interference; identifying one or more radio channels causing the interference as interfering channels; causing selection of one or more other user equipment, which have been determined to monitor at least one of the identified one or more interfering channels; based on the examination instructing one or more of the existing one or more other user equipment to obtain information of one or more of the interfering channels; obtaining information of the selected one or more other user equipment; providing the information of the selected one or more other user equipment to the first user equipment for establishing a sidelink connection with the selected one or more other user equipment and for receiving information of the one or more interfering channels; instructing the first user equipment to perform positioning measurements; and receiving information of the positioning measurements from the first user equipment.

### TECHNICAL FIELD

The present invention relates to apparatuses, methods and computer program products for enablement of co-occurrence of positioning and communications services via a sidelink-based collaborative service-conflict resolution scheme.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

3GPP has been developing standards for New Radio sidelink (NR SL) to facilitate a user equipment (UE) to communicate with other nearby UE(s) via direct/SL communication. Two resource allocation modes have been specified, and a SL transmitter (Tx) UE is configured with one of them to perform its NR SL transmissions. These modes are denoted as NR SL mode 1 and NR SL mode 2. In mode 1, a sidelink transmission resource is assigned by a network (NW) to the SL Tx UE, while a SL Tx UE in mode 2 autonomously selects its SL transmission resources.

NR positioning is based on the use of a location server. The location server collects and distributes information related to positioning to the other entities which take part of the positioning procedures. The distributed information may comprise information of UE capabilities, assistance data, measurements, position estimates and so on.

In a downlink (DL) based positioning a reference signal called as a positioning reference signal (PRS) can be used. A user equipment may receive positioning reference signals from a plurality of distinct base station and measure a time of arrival (ToA) of the received positioning reference positioning reference signals. The UE can then report the ToA differences to a location server. The location server can use the reports to determine the position of the UE.

The PRS signal sent by a gNB is orthogonalized in time-frequency and code with other PRS signals i.e., PRS signals sent by different gNBs. The PRS signal sent by a gNB is also orthogonalized in time-frequency and code with synchronization signal blocks (SSBs) sent by the same gNB. However, this does not prevent the PRS of a serving gNB and data and/or control from different gNBs (henceforth called foreign channels) to use the same PRBs and cause co-channel interference at a target UE as depicted in FIG. 6. Here, the PRS from a far-away transmission reception point (TRP) (the gNB 601 in FIG. 6) are being interfered by the much stronger SSBs sent by a closer gNB (the gNB 602). This near-far problem may cause that the target UE fails to decode the PRS and to compute reliable positioning measurements. Ultimately, this situation may result in inaccurate position estimates.

### SUMMARY

There is provided a method, apparatus and computer program product for enhanced accuracy positioning. There is provided a collaborative framework among neighbour devices that allows coexistence of positioning and communication applications in the same spectrum without relying on advanced positioning receiver capabilities at the target UE side.

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to some aspects, there is provided the subject matter of the independent claims. Some further aspects are defined in the dependent claims. The embodiments that do not fall under the scope of the claims are to be interpreted as examples useful for understanding the disclosure.

This invention enables co-occurrence of positioning and communications services via a SL-based collaborative service-conflict resolution scheme.

According to a first aspect there is provided a method for enhanced accuracy positioning comprising:
determining that a first user equipment is likely to experience positioning interference:
identifying one or more radio channels causing the interference as interfering channels:
causing selection of one or more other user equipment, which have been determined to monitor at least one of the identified one or more interfering channels:
based on the examination instructing one or more of the existing one or more other user equipment to obtain information of one or more of the interfering channels:
obtaining information of the selected one or more other user equipment:
providing the information of the selected one or more other user equipment to the first user equipment for establishing a sidelink connection with the selected one or more other user equipment and for receiving information of the one or more interfering channels:
instructing the first user equipment to perform positioning measurements; and
receiving information of the positioning measurements from the first user equipment.

According to a second aspect there is provided an apparatus, comprising means for:
determining that a first user equipment is likely to experience positioning interference:
identifying one or more radio channels causing the interference as interfering channels:
causing selection of one or more other user equipment, which have been determined to monitor at least one of the identified one or more interfering channels:
based on the examination instructing one or more of the existing one or more other user equipment to obtain information of one or more of the interfering channels:
obtaining information of the selected one or more other user equipment:
providing the information of the selected one or more other user equipment to the first user equipment for establishing a sidelink connection with the selected one or more other user equipment and for receiving information of the one or more interfering channels:
instructing the first user equipment to perform positioning measurements; and
receiving information of the positioning measurements from the first user equipment.

According to a third aspect there is provided an apparatus comprising at least one processor; and at least one memory including computer program code: the at least one memory and the computer program code configured to, with the at least one processor, to cause the apparatus to:
determine that a first user equipment is likely to experience positioning interference:
identify one or more radio channels causing the interference as interfering channels:
cause selection of one or more other user equipment, which have been determined to monitor at least one of the identified one or more interfering channels:
obtain information of the selected one or more other user equipment:
provide the information of the selected one or more other user equipment to the first user equipment for establishing a sidelink connection with the selected one or more other user equipment and for receiving information of the one or more interfering channels:
instruct the first user equipment to perform positioning measurements; and
receive information of the positioning measurements from the first user equipment.

According to a fourth aspect there is provided a computer program product comprising computer readable program code configured to, with at least one processor, cause an apparatus to perform at least the following:
determine that a first user equipment is likely to experience positioning interference:
identify one or more radio channels causing the interference as interfering channels:
cause selection of one or more other user equipment, which have been determined to to monitor at least one of the identified one or more interfering channels:
obtain information of the selected one or more other user equipment:
provide the information of the selected one or more other user equipment to the user equipment for establishing a sidelink connection with the selected one or more other user equipment and for receiving information of the one or more interfering channels:

instruct the first user equipment to perform positioning measurements; and
receive information of the positioning measurements from the first user equipment.

According to a fifth aspect there is provided a method comprising:
receiving from a location management function a request for selection of one or more other user equipment, which have been determined to monitor at least one of the one or more radio channels identified in the request:
using or modifying a location management function parameterization; and
selecting one or more of said other user equipment to collect channel information of one or more of the identified radio channels and to estimate channel conditions towards the one or more of the identified channels:
sending the location management function parameterization to the selected one or more other user equipment; and
sending the location management function parameterization and information of the selected one or more other user equipment to the location management function.

According to a sixth aspect there is provided an apparatus comprising means for:
receiving from a location management function a request for selection of one or more other user equipment, which have been determined to monitor at least one of the one or more radio channels identified in the request:
using or modifying a location management function parameterization; and
selecting one or more of said other user equipment to collect channel information of one or more of the identified radio channels and to estimate channel conditions towards the one or more of the identified channels:
sending the location management function parameterization to the selected one or more other user equipment; and
sending the location management function parameterization and information of the selected one or more other user equipment to the location management function.

According to a seventh aspect there is provided an apparatus comprising at least one processor; and at least one memory including computer program code: the at least one memory and the computer program code configured to, with the at least one processor, to cause the apparatus to:
receive from a location management function a request for selection of one or more other user equipment, which have been determined to monitor at least one of the one or more radio channels identified in the request:
use or modifying a location management function parameterization; and
select one or more of said other user equipment to collect channel information of one or more of the identified radio channels and to estimate channel conditions towards the one or more of the identified channels:
send the location management function parameterization to the selected one or more other user equipment; and
send the location management function parameterization and information of the selected one or more other user equipment to the location management function.

According to an eighth aspect there is provided a computer program product comprising computer readable program code configured to, with at least one processor, cause an apparatus to perform at least the following:
receive from a location management function a request for selection of one or more other user equipment, which have been determined to monitor at least one of the one or more radio channels identified in the request:
use or modifying a location management function parameterization; and
select one or more of said other user equipment to collect channel information of one or more of the identified radio channels and to estimate channel conditions towards the one or more of the identified channels:
send the location management function parameterization to the selected one or more other user equipment; and
send the location management function parameterization and information of the selected one or more other user equipment to the location management function.

According to a ninth aspect there is provided a method comprising:
receiving information of selected one or more other user equipment:
establishing a sidelink connection with the selected one or more other user equipment; and
receiving information of one or more interfering channels:
receiving positioning reference signals:
using the received information of interfering channels to at least partially suppress the effect of interference from the positioning reference signals; and
sending information of the positioning measurements to a location management function.

According to a tenth aspect there is provided an apparatus comprising means for:
receiving information of selected one or more other user equipment:
establishing a sidelink connection with the selected one or more other user equipment; and
receiving information of one or more interfering channels:
receiving positioning reference signals:
using the received information of interfering channels to at least partially suppress the effect of interference from the positioning reference signals; and
sending information of the positioning measurements to a location management function.

According to an eleventh seventh aspect there is provided an apparatus comprising at least one processor; and at least one memory including computer program code: the at least one memory and the computer program code configured to, with the at least one processor, to cause the apparatus to:
receive information of selected one or more other user equipment:
establish a sidelink connection with the selected one or more other user equipment; and
receive information of one or more interfering channels:
receive positioning reference signals:
use the received information of interfering channels to at least partially suppress the effect of interference from the positioning reference signals; and
send information of the positioning measurements to a location management function.

According to a twelth aspect there is provided a computer program product comprising computer readable program code configured to, with at least one processor, cause an apparatus to perform at least the following:
receive information of selected one or more other user equipment:
establish a sidelink connection with the selected one or more other user equipment; and
receive information of one or more interfering channels:
receive positioning reference signals:
use the received information of interfering channels to at least partially suppress the effect of interference from the positioning reference signals; and
send information of the positioning measurements to a location management function.

### BRIEF DESCRIPTION OF THE DRAWINGS

For a more complete understanding of example embodiments of the present invention, reference is now made to the following descriptions taken in connection with the accompanying drawings in which:

FIG. 1 shows a part of an exemplifying wireless communications access network in accordance with at least some embodiments of the present invention;

FIG. 2 illustrates an example of a communication setup in which some embodiments may be implemented:

FIG. 3 illustrates an example of an NR SL resource allocation mode 1:

FIG. 4 illustrates an example of an NR SL resource allocation mode 2:

FIG. 5a illustrates an inter-UE coordination scenario, in which a coordinating UE is also an intended receiver of UE B's transmission: (b) The coordinating UE (UE A) is not the intended receiver of the UE B's transmission:

FIG. 5b illustrates an inter-UE coordination scenario, in which the coordinating UE is not the intended receiver of the UE B's transmission:

FIG. 6 illustrates an example of a situation in which an SSB sent by a TRP far-away from a UE is disturbed by transmission of an SSB by a TRP nearer to the UE:

FIG. 7 illustrates an example of a use case scenario, in accordance with an embodiment:

FIG. 8 is a signalling diagram in accordance with an embodiment:

FIG. 9a is a flow diagram of a method for a location management function, in accordance with an embodiment:

FIG. 9b shows a flow diagram of a method for a gNB, in accordance with an embodiment:

FIG. 9c shows a flow diagram of a method for a user equipment, in accordance with an embodiment; and

FIG. 10 illustrates an apparatus in accordance with an embodiment.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

A radio device may be a device configured for communications on radio waves over a wireless radio link, i.e. a wireless link. The communications may comprise user traffic and/or signaling. The user traffic may comprise data, voice, video and/or audio. Examples of the wireless link comprise a point-to-point wireless link and a point-to-multipoint wireless link. The wireless link may be provided between two radio devices. It should be appreciated that the radio devices may have differences. For example, radio devices connected by a wireless link may comprise one or more of a user equipment (UE), an access node, an access point, a relay node, a user terminal and an Internet of Things (IoT) device.

A radio device may be a radio access device that is configured to serve a plurality of other radio devices, user radio devices, and give radio access to a communications system for the user radio devices. A radio device may also be a radio station serving as relay node or providing a wireless backhaul for one or more radio access nodes. Examples of the radio access devices comprise at least an access node, an access point, a base station and an (c/g) NodeB. Examples of the user radio devices comprise at least a user terminal and user equipment (UE). The radio device may be an aerial radio device and/or an extraterrestrial radio device configured to operate above the ground without a fixed installation to a specific altitude. Examples of extra-terrestrial radio devices comprise at least satellites and spacecraft that are configured for radio communications in a communications system that may comprise both terrestrial and extraterrestrial radio devices. Examples of aerial radio devices comprise at least High Altitude Platform Stations (HAPSs) and unmanned aerial vehicles (UAVs), such as drones. The radio access device may have one or more cells which the user radio devices may connect to in order to access the services of the communications system via the radio access device. The cells may comprise different sizes of cells, for example macro cells, micro cells, pico cells and femto cells. A macro cell may be a cell that is configured to provide coverage over a large coverage area in a service area of the communications system, for example in rural areas or along highways. A micro cell may be a cell that is configured to provide coverage over a smaller coverage area than the macro cell, for example in a densely populated urban area. Pico cells may be cells that are configured to provide coverage over a smaller area than the micro cells, for example in a large office, a mall or a train station. Femto cells may be cells that are configured to provide coverage over a smaller area than the femto cells, for example at homes or small offices. For example, macro cells provide coverage for user radio devices passing a city on a motorway/highway and local cells, e.g. micro cells or smaller cells, provide coverage for user radio devices within the city. In another example, macro cells provide coverage for aerial radio devices and/or extraterrestrial radio devices and local cells, e.g. micro cells or smaller cells, provide coverage for the aerial radio devices and/or extraterrestrial radio devices that are located at elevated positions with respect to one or more radio access devices of the communications system. Accordingly, an aerial radio device or extraterrestrial radio device may be connected to a micro cell of a radio access device and when the aerial radio device or extraterrestrial radio device is above a certain height from the ground, the aerial radio device or extraterrestrial radio device may be switched to a macro cell, for example by a handover procedure.

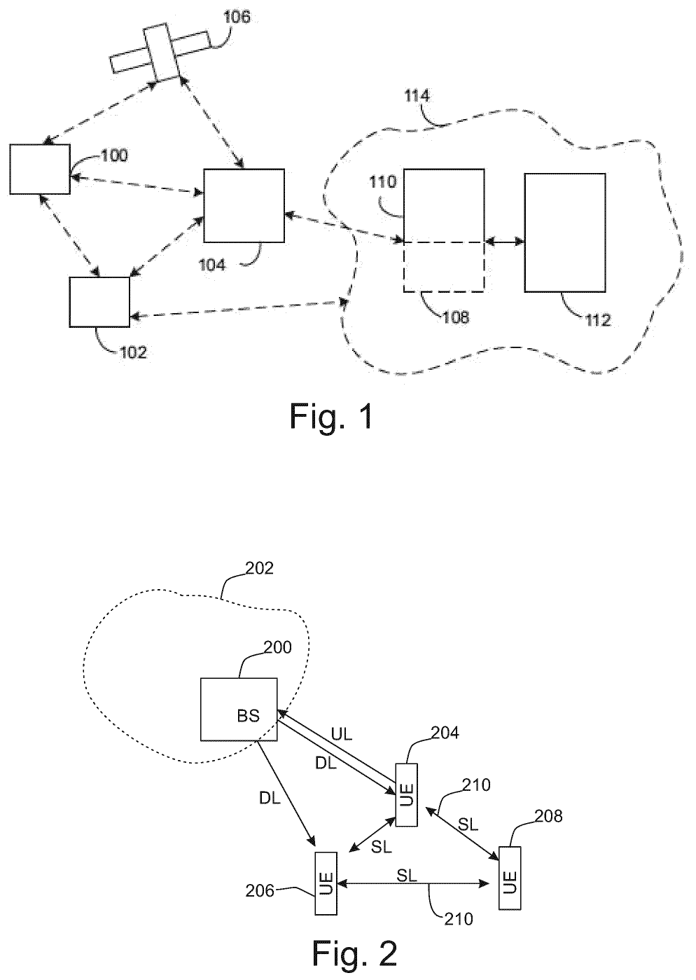

FIG. 1 depicts examples of simplified system architectures only showing some elements and functional entities, all being logical units, whose implementation may differ from what is shown. The connections shown in FIG. 1 are logical connections: the actual physical connections may be different. It is apparent to a person skilled in the art that the system typically comprises also other functions and structures than those shown in FIG. 1.

The example of FIG. 1 shows a part of an exemplifying radio access network.

FIG. 1 shows user devices 100 and 102 configured to be in a wireless connection on one or more communication channels in a cell with an access node (such as (c/g) NodeB, which may also be abbreviated as eNB/gNB) 104 providing the cell. The physical link from a user device to a (c/g) NodeB is called uplink or reverse link and the physical link from the (e/g) NodeB to the user device is called downlink or forward link. It should be appreciated that (c/g) NodeBs or their functionalities may be implemented by using any node, host, server or access point etc. entity suitable for such a usage. The access node provides access by way of communications of radio frequency (RF) signals and may be referred to a radio access node. It should be appreciated that the radio access network may comprise more than one access nodes, whereby a handover of a wireless connection of the user device from one cell of one access node, e.g. a source cell of a source access node, to another cell of another node, e.g. a target cell of a target access node, may be performed.

The communication channels for wireless connection may also be called as wireless communication channels implemented by way of radio frequency signals, also called as radio channels.

A communication system typically comprises more than one (c/g) NodeB in which case the (c/g) NodeBs may also be configured to communicate with one another over links, wired or wireless, designed for the purpose. These links may be used for signaling purposes. The (c/g) NodeB is a computing device configured to control the radio resources of communication system it is coupled to. The NodeB may also be referred to as a base station, an access point or any other type of interfacing device including a relay station capable of operating in a wireless environment. The (c/g) NodeB includes or is coupled to transceivers. From the transceivers of the (c/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, wireless device, communications device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cm Wave and mm Wave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mm Wave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, an operations and maintenance manager, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (c/g) NodeBs, the user device may have an access to a plurality of radio cells and the system may comprise also other apparatuses, such as physical layer relay nodes or other network elements, etc. At least one of the (c/g) NodeBs or may be a Home (c/g) NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (c/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

The embodiments are not, however, restricted to the system given as an example but a person skilled in the art may apply the solution to other communication systems provided with necessary properties.

The nature of the sidelink (SL) is oriented according to a transmitting user equipment (Tx UE) wherein a receiving user equipment (Rx UE) may need to keep monitoring all possible PSCCH (Physical Sidelink Control Channel) instances to receive sidelink transmission over one or more preconfigured resource pool(s). There are at least the following two allocation modes for sidelink transmissions. The first mode, Mode 1, is a base station (BS) scheduled mode in which the serving base station allocates resources for the user equipment for sidelink transmission, and the second mode, Mode 2, is an autonomous UE selected mode, in which the user equipment may allocate resources for the sidelink transmission without base station intervention. These modes, which may also be denoted as NR SL mode 1 and NR SL mode 2, make no difference to a receiving user equipment Rx UE in term of receiving sidelink, regardless of whether the sidelink is for broadcast, groupcast or unicast. The sidelink can be applied for both in-coverage and out-of-coverage situations with multi-PLMN support (Tx UE and Rx UE from different serving PLMNs).

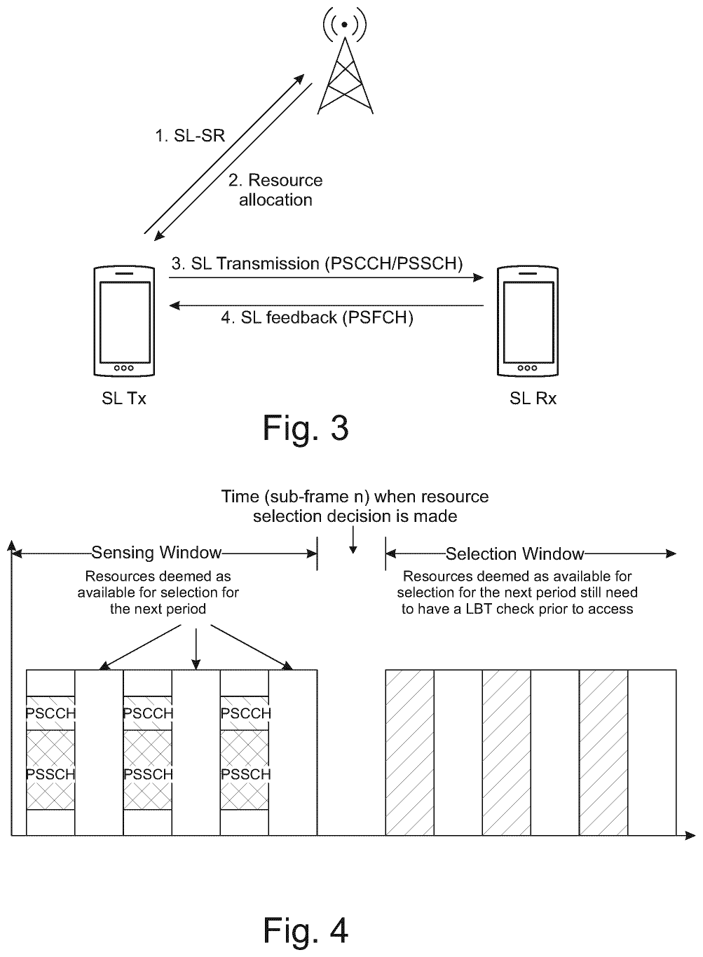

In the following, an overview of NR sidelink is shortly explained with reference to FIGS. 3 and 4, in accordance with an approach.

In mode 1, where the gNB is responsible for the SL resource allocation, the configuration and operation is similar to the one over the Uu interface, which is depicted in FIG. 3 in a simplified manner. If a first UE (SL Tx) receives information to be transmitted to a second UE (SL Rx) utilizing the sidelink transmission, the first UE sends a sidelink resource request SL-SR to the gNB. As soon as the sidelink request is authorized and if the gNB can reserve resources to the first UE, the gNB may offer resource allocation for the PSCCH and PSSCH (physical sidelink shared channel). The PSSCH carries data and the PSCCH carries control information for decoding the data channel. The gNB sends a resource allocation information to the first UE which may then use this information to initiate sidelink communication with the second UE. The first UE may then perform transmission to the second UE via the PSCCH and PSSCH. The second UE may acknowledge the received packets by sending an acknowledgement in a physical sidelink feedback channel (PSFCH) to the first UE. In some approaches the acknowledgment may only be sent when there is an error in the reception of packets from the first UE.

In mode 2, the first UE and the second UE perform sidelink establishment autonomously so that the first UE performs resource selection with the aid of a sensing procedure. More specifically, a SL Tx UE in NR SL mode 2 first performs a sensing procedure over the configured SL transmission resource pool(s), in order to obtain the knowledge of the reserved resource(s) by other nearby SL Tx UE(s). Based on the knowledge obtained from sensing, the SL Tx UE may select resource(s) from the available SL resources, accordingly. In order for a SL UE to perform sensing and obtain the necessary information to receive a SL transmission, it needs to decode the sidelink control information (SCI).

In other words, in Mode 2 the sensing operation may comprise sensing first within a sensing window, then excluding resources reserved by other UEs, and selecting final resources within a selection window. In Mode 2, shortly before transmitting in a reserved resource, the first UE re-evaluates the set of resources to check whether its intended transmission is still suitable. In this re-evaluation the first UE may consider a possible aperiodic transmission after the resource reservation. If the reserved resources would not be part of the set for selection at this time, then new resources are selected from the updated resource selection window. In addition to the re-evaluation, pre-emption is also introduced such that a UE selects new resources even after it announces the resource reservation when it observes resource collision with a higher priority transmission from another UE. This procedure is illustrated in FIG. 4, in accordance with an approach.

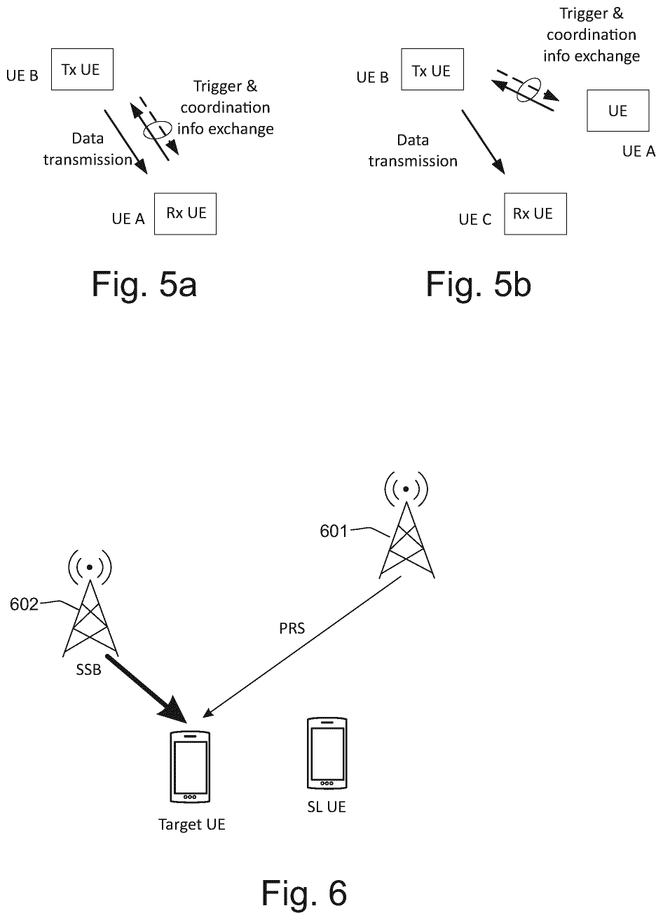

In the following, some details of an inter-UE coordination will be described with reference to FIGS. 5a and 5b, in accordance with an approach.

In the example of FIG. 5a, in which the coordinating UE (UE A) is also the intended receiver of UE B's transmission, a set of resources is determined at the UE-A. This set is sent to the UE-B in mode 2, and the UE-B takes this into account in the resource selection for its own transmission. The solution may be able to operate in-coverage, partial coverage, and out-of-coverage and to address consecutive packet loss in all coverage scenarios.

In one of the inter-UE coordination scenarios in which the coordinating UE (UE A) is not the intended receiver of the UE B's transmission, depicted in FIG. 5b, the UE A (Rx-UE) selects the preferred SL transmit resource(s) (e.g., according to results of its sensing procedure) and recommends the selected resource(s) to UE B (Tx-UE), where the UE B selects its SL transmit resource by taking into account the resource(s) indicated by the UE A and in addition performing its own sensing, e.g., the UE B may use or may not use the recommended resource(s) to transmit to the UE A. Thus, by using the inter-UE coordination scheme, the UE A may try to ensure there is no packet collision or strong interference over its selected resource(s) and, thus, the transmission from the UE B to the UE A can occur with high(er) reliability.

In another Inter-UE coordination scenario (denoted in 3GPP as inter-UE Coordination Scheme 2), the UE A monitors the transmissions taking place in the SL resource pool and every time a collision or half-duplex problem is detected, either in the past or in future resources, and then the UE A informs the impacted UEs.

As was mentioned earlier in this specification, the near-far problem may cause the target UE to fail to decode the positioning reference signals and to compute reliable positioning measurements possibly resulting in inaccurate position estimates. One straightforward solution would be to orthogonalize positioning reference signals with respect to foreign control signals like synchronization signal blocks (or in the extreme case all other data signals). However, this solution is unscalable, for two main reasons. First, a single target UE needs to periodically receive positioning reference signals from multiple sources, such as from both a serving and a non-serving cell, and such solution would ultimately result in reserving most, if not all the available spectrum for positioning purposes only. Second, increased network densification means high likelihood that other nearby UEs need to be served while performing positioning of the target UE.

A much more computationally expensive solution would be for the target UE to attempt to decode and cancel the interference coming from the SSBs, prior to decoding the PRS. Such approach is not suitable for latency sensitive positioning and/or limited-power UEs which are typically not equipped with positioning receivers capable of advanced interference estimation and/or cancellation.

To overcome the shortcomings of the above solutions, a collaborative framework among neighbour devices has been developed that allows coexistence of positioning and communication applications in the same spectrum without relying on advanced positioning receiver capabilities at the target UE side.

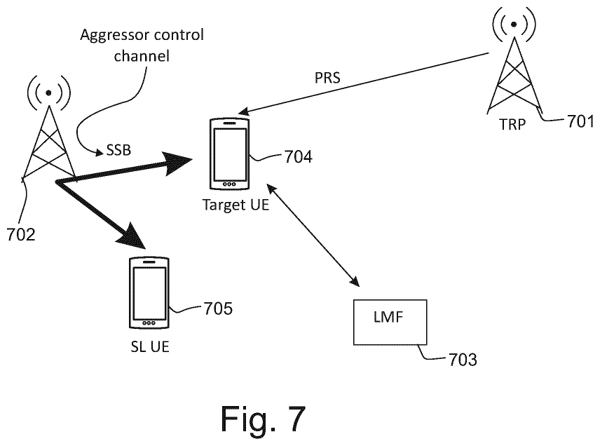

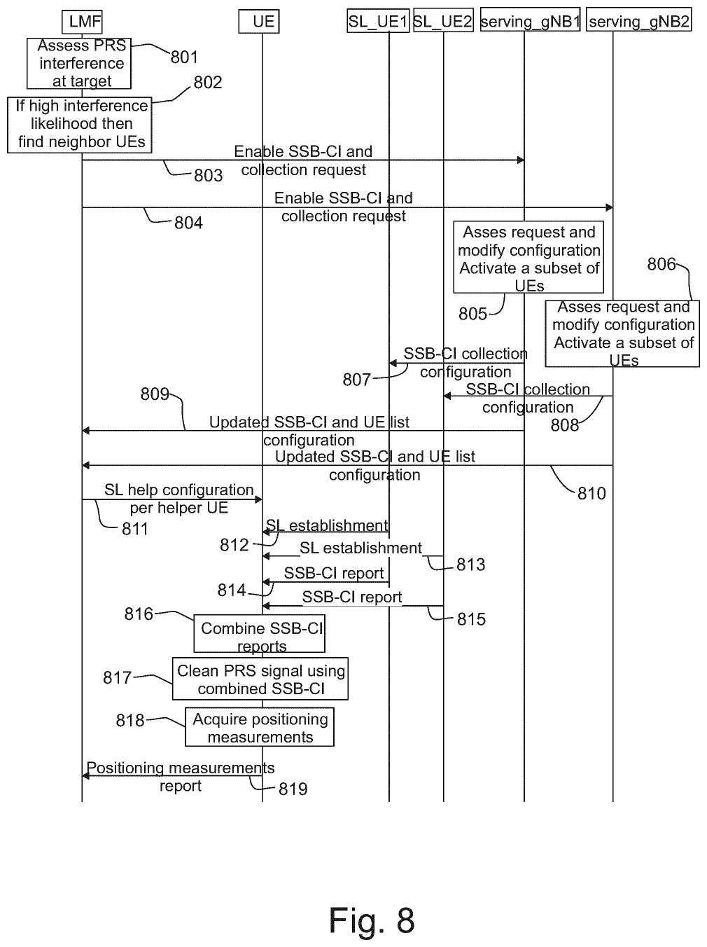

An example scenario is depicted in FIG. 7, and an example of signalling is depicted in FIG. 8, in accordance with an embodiment. The target UE 704 is triggered at a first time instant t1 to perform downlink positioning. Since the positioning reference signals from the transmission reception point (TRP) gNB 701 are interfered by the much stronger synchronization signal blocks (SSB) from the other gNB 702, which is closer to the target UE 704 than the gNB 701, it may happen that the positioning reference signals from the transmission reception point gNB 701 cannot be successfully decoded, and the localization accuracy is compromised. To mitigate this situation, following procedure may be utilized.

A location management function (LMF) 703 receives a localization request for the target UE 704. The location management function 703 assesses (block 801 in FIG. 8) whether the target UE 704 is likely to experience positioning interference. For example, based on serving cell/beam information, the LMF 703 may be able to find out a coarse location of the target UE 704. This coarse location may be or may have been associated with high levels of heterogeneous interference as reported by other past/current target UEs, e.g. by the UE 705, or flagged by one or more gNBs via explicit NR positioning protocol A (NRPPa) messaging triggered by an LMF request.

Based on a result of the levels of heterogeneous interference reported by other past and/or current target UEs or flagged by one or more gNBs, the location management function 703 identifies what channels are causing the interference. Such channel is called in this specification as an aggressor channel.

If the outcome of the identification is positive, i.e. interference by one/more foreign control channels is likely, the location management function 703 identifies 802 one or more nearby neighbor UEs that are actively monitoring the channel(s) deemed as aggressors for their own radio resource management (RRM) purposes i.e. estimate channel conditions towards the aggressor channel(s) e.g. by estimating propagation conditions of the aggressor channels i.e. wireless channels. An example of a nearby UE is the SL-UE 705 in FIG. 7. Such a neighbor UE may be defined as a UE that shares the same serving beam index, cell sector, etc.

The location management function 703 requests 803 the gNB (serving_gNB1 in the example of FIG. 8), which is serving the one or more SL-UEs, to enable the UE served by this gNB (SL_UE1) to record and share the aggressor control channel information (SSB-CI) to the target UE. Such SSB-CI may refer to channel frequency response (CFR), impulse response, main path gain and delay, etc.

In the example of FIG. 8 the location management function 703 also requests 804 another gNB (serving_gNB2) to enable the UE served by this gNB (SL_UE2) to record and share the aggressor control channel information (SSB-CI) to the target UE.

The messages 803, 804 may contain an explicit list of neighbor UEs IDs e.g. in case that the LMF 703 has previously/recently localized them or a blanket-request for SSB-CI using the serving cell, serving beam index of the target UE. This means that the gNBs need themselves to select the helper UEs, using the target UE's information and the SSB-CI configuration request.

After the corresponding gNBs have assessed the LMF request, they use and/or modify 805, 806 the LMF parameterization and select one or more helper UEs to collect SSB-CI. Subsequently, the serving gNB1 configures the corresponding SL sessions by sending an SSB-CI collection configuration message 807 to the SL_UE1 and, correspondingly, the serving_gNB2 configures the corresponding SL sessions by sending an SSB-CI collection configuration message 808 to the SL_UE2. The SSB-CI collection configuration messages 807, 808 indicate to the helpers (i.e. SL_UE1, SL_UE2 in the example of FIG. 8) a strategy for collecting SSB-CI e.g. duration, bandwidth part (BWP), etc. The serving_gNB1 reports modifications and SL-UEs down-selection back to the LMF via sending a message 809 to the location management function 703 and the serving gNB2 reports corresponding modifications and SL-UEs down-selection back to the location management function 703 via sending a message 810 to the location management function 703. The location management function 703 propagates the reported modifications and SL-UEs down-selection for each selected helper UE to the target UE via a message 811. It should be noted that the impeding SL session may also be communicated to the serving gNB of the target UE, either by the location management function 703 directly (via NRPPa), or by the target UE (via RRC signalling).

Sharing the aggressor control channel information SSB-CI is realized over SL, at a time instance t2, where t2 may be immediately preceding or following the time instance t1, as determined by the location management function 703. The SL-based sharing can be realized by broadcast/groupcast messages and in this way all target UEs in the vicinity can take advantage of this information or unicast messaging where a single target UE will benefit.

The serving gNB configures SL-UE to record SSB-CI for time instances t<t1 (i.e. before the target UE 704 is triggered to perform downlink positioning), and to establish a sidelink to the target UE for sharing SSB-CI with the target UE at the time instant t2.

The location management function 703 triggers DL positioning for target UE at the time instant t1, and the target UE collects the positioning reference signal samples as instructed.

At time t2, once the messages 811, 807 and 808 have been received, the SL sessions can be deployed and started. The target UE and SL-UE1 establish 812 SL communication and the target UE receives SSB-CI from the SL_UE1. Similarly, also the target UE and SL-UE2 establish 813 SL communication and the target UE receives SSB-CI from the SL_UE2. After receiving the collected SSB_Cis from the helper UEs, i.e. SL_UE1 and SL_UE2, the target UE runs the measurements through blocks 816 and 817, before collecting its own PRS measurements (block 818).

Next, a procedure the target UE may perform in block 816 is described, in accordance with an embodiment.

Depending on the type of reporting, the target UE may combine the SSB_CI reports using different strategies. For example, if SSB-CI is reported as the channel frequency response (CFR), then the target UE may perform one or more of the following:
apply a weighted average operation among all CFR reports;
perform an inverse fast fourier transform (IFFT) on each channel frequency response (CFR), superimpose the results. For example, the target UE may interleave the resulting channel impulse response (CIR), and then perform an FFT to obtain the combined channel frequency response;
apply a phase shift to the resulting CIR proportional to the distance to the SL-UE; and/or
apply a one-dimensional (1D), two-dimensional (2D) or three-dimensional 3D filtering (e.g. Wiener) of all channel frequency responses, depending on whether the channel frequency responses were collected on different subcarriers, different time instances, and different helper UE locations. It should be noted that 1D filtering refers to frequency-domain filtering, 2D refers to both frequency and time, while 3D introduces the additional spatial filtering, i.e. accounts for the channel's spatial correlation between the different locations.

In another example, if the SSB-CI is reported as a channel impulse response, the target UE may interleave the channel impulse response taps in the increasing order of their delays, and then perform an FFT to obtain the combined channel frequency response.

It should be noted that if the target UE receives SSB_CI reports only from one SL_UE, the combination procedure of 816 need not be performed.

The block 817 illustrates utilization of the generated interference model by the target UE. The target UE may use the generated interference model of the aggressor channel and use it to clean the received PRS samples e.g. by interference rejection/cancellation type of techniques such as serial/parallel interference cancellation, iterative interference cancellation, etc. Subsequently the target UE then proceeds to perform the standard positioning measurements on the resulting signal. It should be noted that in case that multiple SL-UEs are sharing their respective SSB-CI, the target UE should first obtain a combined SSB-CI and then clean the signal, using the combined channel impulse (CI).

In this context cleaning the signal does not necessarily mean that the effect of interference is totally eliminated but partially suppressed.

The combined SSB-CI may be realized by e.g., means of weighted average, where the weights are proportional to the SL physical channel SNR, or inversely proportional to the distance to each SL-UE, to the age of the SSB-CI report, etc.

In another embodiment, the weights may be computed as phase shifts of the channel impulse proportional to the distance to the SL-UE.

If the channel impulse is represented as CIR, or main tap, the combined SSB-CI may be obtained by superimposition of all taps.

When the target UE has performed the cleaning of the received PRS samples the target UE may perform positioning measurements and collect 818 the PRS measurements. Results of the positioning measurements may be reported 819 by the target UE to the location management function 703.

It should be noted that although the above description showed that two SL_UEs were participating the procedure, the number of SL_UEs is not limited to two but the number of participating SL_UEs may also be greater than two or only one SL_UE may take part of the procedure. Moreover, the number of participating SL_UEs may be different in different situations.

The above-described procedures may enable spectrally efficient positioning and communications services e.g. because the interference of strong other signals may be reduced.

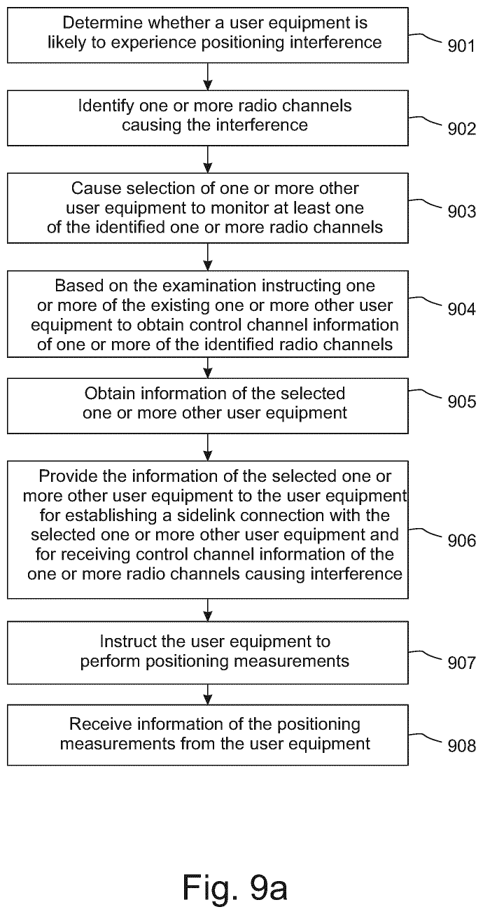

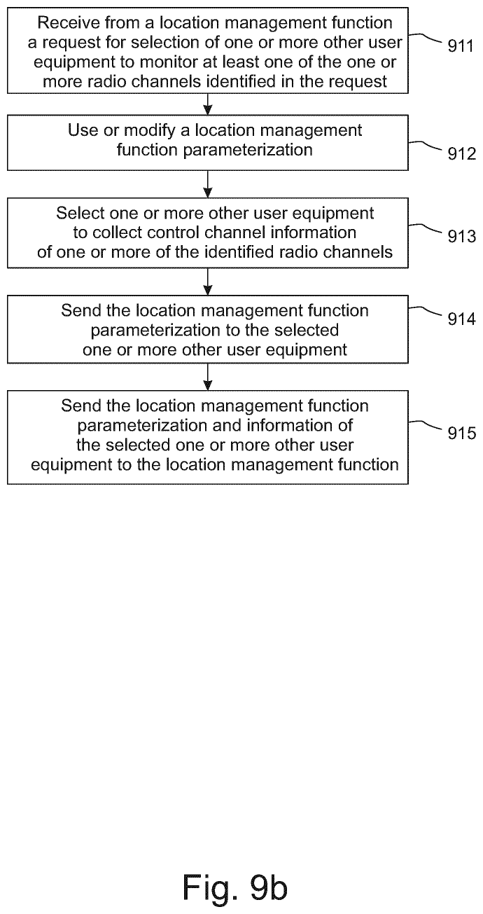

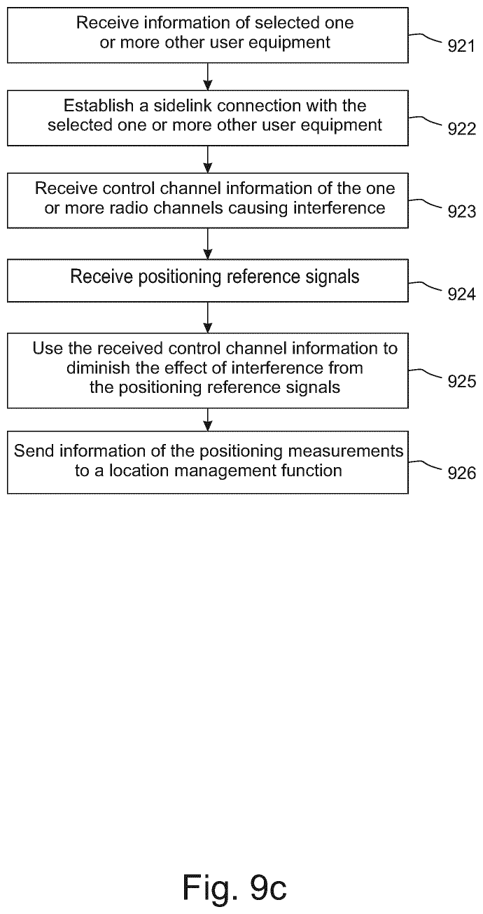

FIG. 9a shows a flow diagram of a method for the location management function 703, in accordance with an embodiment. The method comprises determining 901 that a user equipment is likely to experience positioning interference: identifying 902 one or more radio channels causing the interference: causing 903 selection of one or more other user equipment monitoring at least one of the identified one or more radio channels: based on the examination instructing 904 one or more of the existing one or more other user equipment to obtain control channel information of one or more of the identified radio channels: obtaining 905 information of the selected one or more other user equipment; providing 906 the information of the selected one or more other user equipment to the user equipment for establishing a sidelink connection with the selected one or more other user equipment and for receiving control channel information of the one or more radio channels causing interference:

instructing 907 the user equipment to perform positioning measurements; and receiving 908 information of the positioning measurements from the user equipment.

FIG. 9b shows a flow diagram of a method for the gNB, in accordance with an embodiment. The method comprises receiving 911 from a location management function a request for selection of one or more other user equipment to monitor at least one of the one or more radio channels identified in the request: using or modifying 912 a location management function parameterization: selecting 913 one or more other user equipment to collect control channel information of one or more of the identified radio channels: sending 914 the location management function parameterization to the selected one or more other user equipment; and sending 915 the location management function parameterization and information of the selected one or more other user equipment to the location management function.

FIG. 9c shows a flow diagram of a method for the user equipment UE, in accordance with an embodiment. The method comprises receiving 921 information of selected one or more other user equipment: establishing 922 a sidelink connection with the selected one or more other user equipment; receiving 923 control channel information of the one or more radio channels causing interference; receiving 924 positioning reference signals: using 925 the received control channel information to at least partially suppress the effect of interference from the positioning reference signals; and sending 926 information of the positioning measurements to a location management function.

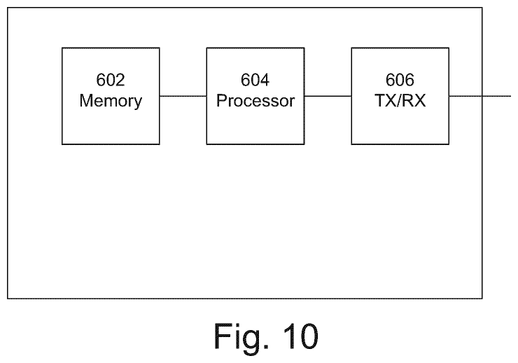

FIG. 10 illustrates an example of an apparatus in accordance with at least some embodiments of the present invention. The apparatus may be a radio device, for example a radio access node or a user radio device. The apparatus may perform one or more functionalities according to examples described herein.

The apparatus comprises a processor 602 and a transceiver 604. The processor is operatively connected to the transceiver for controlling the transceiver. The apparatus may comprise a memory 606. The memory may be operatively connected to the processor. It should be appreciated that the memory may be a separate memory or included to the processor and/or the transceiver.

According to an embodiment, the processor is configured to control the transceiver to perform one or more functionalities described according to an embodiment.

A memory may be a computer readable medium that may be non-transitory. The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs) and processors based on multi-core processor architecture, as non-limiting examples.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, computer code etc. should be understood to express software for a programmable processor firmware such as the programmable content of a hardware device as instructions for a processor or configured or configuration settings for a fixed function device, gate array, programmable logic device, etc.

The above described example embodiments or parts of them may be implemented within a user radio device, UE, radio access device or a gNB.

In general, the various embodiments of the disclosure may be implemented in hardware or special purpose circuits or any combination thereof. While various aspects of the disclosure may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analogue and/or digital circuitry) and
(b) combinations of hardware circuits and software, such as (as applicable):
(i) a combination of analogue and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-12. (canceled)

13. An apparatus comprising at least one processor; and at least one memory including computer program code; the at least one memory and the computer program code configured to, with the at least one processor, cause the apparatus to:
determine that a first user equipment is likely to experience positioning interference;
identify one or more radio channels causing the interference as interfering channels;
cause selection of one or more other user equipment, which have been determined to monitor at least one of the identified one or more interfering channels;
obtain information of the selected one or more other user equipment;
provide the information of the selected one or more other user equipment to the first user equipment for establishing a sidelink connection with the selected one or more other user equipment and for receiving information of the one or more interfering channels;
instruct the first user equipment to perform positioning measurements; and
receive information of the positioning measurements from the first user equipment.

14. The apparatus according to claim 13, said at least one memory stored with computer program code thereon, the at least one memory and the computer program code configured to, with the at least one processor, cause the apparatus at least to perform:
send to a gNB, which serves said one or more other user equipment, which have been determined to monitor at least one of the identified one or more interfering channels, a request instructing the gNB to cause one or more other user equipment to record control channel information of one or more interfering channels, estimate and store propagation conditions of one or more interfering channels, and share the obtained information of one or more interfering channels to the first user equipment.

15. The apparatus according to claim 13, said at least one memory stored with computer program code thereon, the at least one memory and the computer program code configured to, with the at least one processor, cause the apparatus at least to:
cause selection of one or more other user equipment among user equipment having at least one of
the same serving beam index,
the same cell sector,
the same neighbor gNB list,
the same second best serving beam index.

16. The apparatus according to claim 13, said at least one memory stored with computer program code thereon, the at least one memory and the computer program code configured to, with the at least one processor, cause the apparatus at least to perform:
send a location management function request to one or more gNBs;
receive one or more responses to the request; and
examine the response to determine whether the response contains an indication of interference.

17. An apparatus comprising at least one processor; and at least one memory including computer program code; the at least one memory and the computer program code configured to, with the at least one processor, cause the apparatus to:
receive from a location management function a request for selection of one or more other user equipment, which have been determined to monitor at least one of the one or more radio channels identified in the request;
use or modify a location management function parameterization;
select one or more of said other user equipment to collect channel information of one or more of the identified radio channels and to estimate channel conditions towards the one or more of the identified channels;
send the location management function parameterization to the selected one or more other user equipment; and
send the location management function parameterization and information of the selected one or more other user equipment to the location management function.

18. The apparatus according to claim 17, said at least one memory stored with computer program code thereon, the at least one memory and the computer program code configured to, with the at least one processor, cause the apparatus at least to perform:
send an SSB-CI collection configuration message to the selected one or more other user equipment indicating the one or more other user equipment a strategy for collecting SSB-CI.

19. An apparatus comprising at least one processor; and at least one memory including computer program code; the at least one memory and the computer program code configured to, with the at least one processor, cause the apparatus to:
receive information of selected one or more other user equipment;
establish a sidelink connection with the selected one or more other user equipment; and
receive information of one or more interfering channels;
receive positioning reference signals;
use the received information of interfering channels to at least partly suppress the effect of interference from the positioning reference signals; and
send information of the positioning measurements to a location management function.

20. The apparatus according to claim 19, said at least one memory stored with computer program code thereon, the at least one memory and the computer program code configured to, with the at least one processor, cause the apparatus at least to perform:
combine a plurality of received channel information to form a combined channel information; and
use the combined channel information to at least partially suppress the effect of interference from the positioning reference signals.

21. The apparatus according to claim 19, said at least one memory stored with computer program code thereon, the at least one memory and the computer program code configured to, with the at least one processor, cause the apparatus at least to:
generate an interference model of the interfering channel based on the received information of interfering channels; and
use the interference model to at least partially suppress the effect of interference.
